(19) United States
(12) Patent Application Publication
(10) Pub. No.: US 2011/0182611 A1
(43) Pub. Date: Jul. 28, 2011

(54) TRANSFER UNIT AND METHOD IN AN ELECTROPHORETIC PRINTING OR COPYING APPARATUS

(76) Inventors: Uwe Hofmann, Valley (DE); Martin Berg, Poing (DE)

(21) Appl. No.: 13/015,846

(22) Filed: Jan. 28, 2011

(30) Foreign Application Priority Data
Jan. 28, 2010 (DE) 10 2010 006 098.4

(51) Int. Cl. G03G 15/16

(52) U.S. Cl. 399/101

(57) ABSTRACT

In a transfer unit or method for an electrophoretic printing or copying apparatus, a rotating transfer element is provided at a first electrical potential arranged adjacent to a charge image carrier and that accepts toner images from the charge image carrier and supplies the toner images to a transfer printing station. An application element is provided adjacent to the transfer element that applies a cleaning fluid onto the transfer element to wet residual toner remaining after the transfer printing. An electrical potential element that recharges the wetted residual toner is provided after the application element and adjacent to the transfer element. A cleaning element after the potential element and adjacent to the transfer element is provided which is at an electrical potential selected so that an electrical field generated between the cleaning element and the transfer element draws the wetted residual toner towards the cleaning element.

### BACKGROUND

For single color or multicolor printing of a printing substrate (for example a single sheet or a belt-shaped recording material) made of the most varied materials, for example paper or thin plastic or metal films, it is known to generate image-dependent potential images (charge images) on a charge image carrier (for example a photoconductor) that correspond to the images to be printed, comprised of regions that are to be inked and regions that are not to be inked. The regions of the potential images that are to be inked are made visible via toner with a developer station. The toner image is subsequently transfer-printed onto the printing substrate.

A liquid developer having at least electronically charged toner, and carrier fluid can thereby be used to ink the potential images. A method for electrophoretic printing in digital printing systems is known from WO 2005/013013 A2 (U.S. 2006/0150836 A1), for example. After the potential images have been generated on the charge image carrier, these are inked with toner by the developer station. A carrier fluid containing silicone oil with ink particles (toner particles) dispersed in it is thereby used as a liquid developer. The feed of the liquid developer to the charge image carrier can take place via an applicator roller to which the liquid developer is supplied by a raster or screen roller at which is arranged a chamber blade. The toner images are subsequently taken up from the charge image carrier by a transfer unit and transferred to the printing substrate. The transfer unit has a transfer element (for example a transfer roller) that transports the toner images to the transfer printing location in a transfer printing station and there interacts with a corona device (for example) in order to transfer the toner images onto the printing substrate. The transfer unit can additionally have a cleaning unit to clean the transfer element, which cleaning is realized as a blade, roller or fabric (such as a fleece) cleaning.

In printers that operate with liquid developer, the cleaning of the transfer element poses additional demands. Since only a little carrier fluid for the toner transport to the printing substrate is provided for the transfer printing onto the printing substrate, the danger exists that toner accumulates at the transfer printing location. Due to the low quantity of carrier fluid, the danger moreover exists that a relatively large amount of toner remains on the transfer element. This toner—called residual toner of a residual image in the following—must be cleaned off the transfer element before the next transfer of a toner image of a new print image. Otherwise a silhouette of the previous transfer-printed print image is obtained together with the new print image.

U.S. 2007/223 980 A1 describes a transfer unit in which a cleaning unit is provided with which the residual toner should be cleaned off a transfer element. The cleaning unit has a pre-cleaning element (preliminary cleaning member), a cleaning element, and an element to clean off the carrier fluid. The pre-cleaning element has the task of loosening the residual toner on the transfer element. For this the pre-cleaning element has contact with the transfer element, sweeps along the transfer element, and scrapes the residual toner from the transfer element. For this the pre-cleaning element has a surface made of a sponge or a brush. Cleaning fluid can be applied onto the pre-cleaning element to loosen the residual toner. This cleaning fluid (for example the carrier fluid) is absorbed by the pre-cleaning element and is released again onto the transfer element by the contact pressure of the pre-cleaning element, wherein the residual toner is distributed in the cleaning fluid.

### SUMMARY

It is an object to specify a transfer unit with a transfer element for an electrophoretic printing or copying apparatus that is embodied such that the residual toner is substantially completely cleaned off the transfer element after the transfer printing of the toner images (corresponding to the print images) onto a printing substrate.

In a transfer unit or method for an electrophoretic printing or copying apparatus, a rotating transfer element is provided at a first electrical potential arranged adjacent to a charge image carrier and that accepts toner images from the charge image carrier and supplies the toner images to a transfer printing station. An application element is provided adjacent to the transfer element that applies a cleaning fluid onto the transfer element to wet residual toner remaining after the transfer printing. An electrical potential element that recharges the wetted residual toner is provided after the application element and adjacent to the transfer element. A cleaning element after the potential element and adjacent to the transfer element is provided which is at an electrical potential selected so that an electrical field generated between the cleaning element and the transfer element draws the wetted residual toner towards the cleaning element.

### BRIEF DESCRIPTION OF THE DRAWINGS

FIG. 1 is a principle representation of a known electrophoretic printing or copying apparatus;

FIG. 2 is an exemplary embodiment of a transfer unit according to the preferred embodiment; and

FIG. 3 is a further development of the transfer unit according to FIG. 2.

### DESCRIPTION OF THE PREFERRED EMBODIMENTS

For the purposes of promoting an understanding of the principles of the invention, reference will now be made to the preferred embodiments/best mode illustrated in the drawings and specific language will be used to describe the same. It will nevertheless be understood that no limitation of the scope of the invention is thereby intended, and such alterations and further modifications in the illustrated method and such further applications of the principles of the inventions as illustrated as would normally occur to one skilled in the art to which the invention relates are included.

According to the preferred embodiments, a cleaning unit is arranged adjacent to the transfer element (which lies at an electrical potential) that takes up toner images from the charge image carrier and supplies these to the transfer printing station for transfer printing onto the printing substrate, the cleaning unit

providing an application element adjacent to the transfer element and after the transfer printing station, which application element applies a cleaning fluid (for example the carrier fluid of the liquid developer) onto the transfer element;

provides a cleaning element after the application element, adjacent to the transfer element, which cleaning element lies at such an electrical potential that an electrically charged residual toner is drawn from the transfer element to the cleaning element; and

provides a potential element between the application element and the cleaning element, which potential element electrically recharges the residual toner in order to increase the electrophoretic mobility of the residual toner in the cleaning fluid.

Respective rotating rollers can be used as an application element, a cleaning element, or a transfer element. A corotron can be used as a potential element. The cleaning fluid should be executed so as to be electrically insulating and good at wetting, wherein the precise conductivity can be adjusted via the addition of charge control substances. For example, the carrier fluid of the liquid developer can be used as a cleaning fluid.

The preferred embodiment therefore has the following advantages: the residual toner is mobilized in the cleaning fluid for a comprehensive cleaning;

the mobilization of the residual toner leads to a high process stability since fluctuations—for example of the toner charge or of roller properties such as resistance or roughness—do not lead to fluctuations of the cleaning efficiency;

the additional cleaning fluid can be the carrier fluid or a fluid optimized for the specific purpose of cleaning;

the independence of the cleaning from the printing substrate, since the cleaning fluid is applied to the transfer element before the cleaning.

The preferred embodiments are explained further using the embodiments that are presented in the drawing figures.

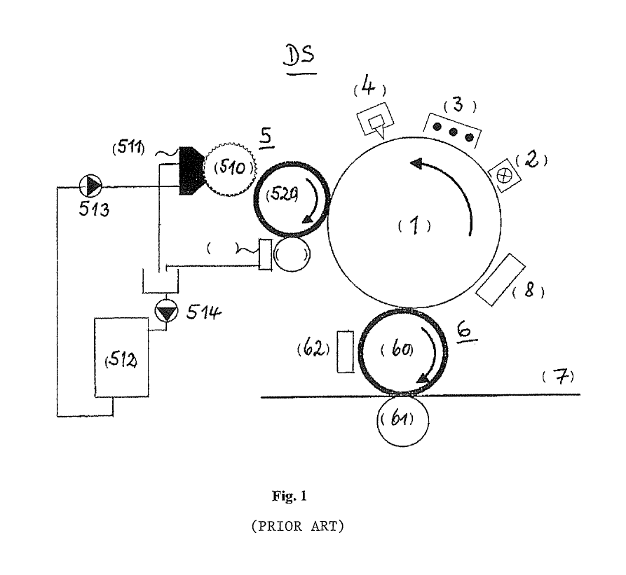

FIG. 1 shows the components of a printing system DS as it is known from WO 2005/013013 A2 corresponding to U.S. 2006/0150836 A1, for example and WO 2005/013013 A2 corresponding to U.S. 2006/0150836 A1 are herewith incorporated into the disclosure. A regeneration exposure 2, a charge station 3, an element 4 for exposure according to the image, a developer device 5, a transfer unit 6 to transfer-print the potential images developed into toner images onto a printing substrate 7, and an element 8 for cleaning the charge image carrier 1 are arranged along a charge image carrier 1 (a photoconductor drum in FIG. 1). The transfer unit 6 has a transfer roller 60, a counter-pressure roller 61 and a cleaning unit 62. For example, the developer device 5 is comprised of an applicator roller 520 which is arranged in contact with the charge image carrier 1. The potential images on the charge image carrier 1 are developed with the applicator roller 520. For this the applicator roller 520 supplies a liquid developer (made up of at least a carrier fluid and electrically charged toner) to the charge image carrier 1. The development takes place in a known manner. For example, the liquid developer of the applicator roller 520 is supplied to the applicator roller 520 by a raster roller 510 with cups and webs via a chamber blade 511 arranged at the raster roller 510, which chamber blade 511 is connected with a reservoir 512 for liquid developer via pumps 513 and 514.

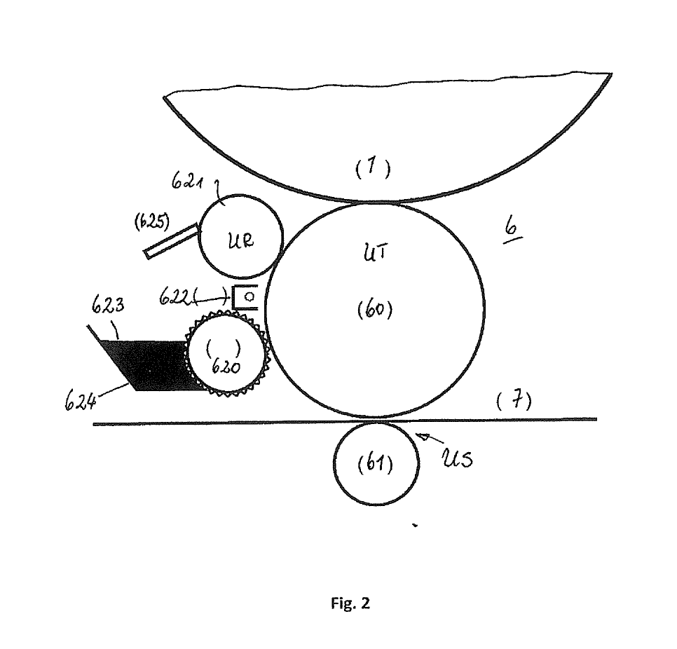

A section of the electrophoretic printing or copying apparatus DS according to FIG. 1 is shown in FIG. 2, and in fact the transfer unit 6 and a portion of the adjacently arranged charge image carrier 1. The transfer unit 6 has as a transfer element a transfer roller 60 lying at an electrical potential UT, which transfer roller 60 is arranged adjacent to a charge image carrier 1 (realized as a photoconductor drum) and a cleaning unit 62. The cleaning unit 62 for its part has an application element 620, a cleaning element 621 and an electrical potential element 622 arranged between the application element 620 and the cleaning element 621. The transfer element 60, the application element 620, and the cleaning element 621 are respectively realized as rotating rollers in FIG. 2; however, the preferred embodiment is not limited to this; these elements can also have a different form, for example as belts. The potential element 622 can be embodied as a corotron. However, in the following explanation of the preferred embodiment a transfer roller 60 as a transfer element, an application roller 620 as an application element, a cleaning roller 621 as a cleaning element and a corotron 622 as a potential element are assumed. The application roller 620 can be embodied as a raster roller that takes up cleaning fluid 623 from a pan 624 and applies it to the surface of the transfer roller 60.

The toner images of the print images are transferred onto the printing substrate 7 at the transfer printing station US. An unwanted residue of toner (the residual toner) and possibly also a residue of carrier fluid thereby remain on the transfer roller 60. These residues of toner and carrier fluid must be cleaned off the transfer roller 60 before new toner images are accepted from the charge image carrier 1.

In order to optimize the cleaning process, the cleaning fluid 623 is transferred onto the surface of the transfer roller 60 by the application roller 620 (arranged after the transfer printing station US), and in particular the residual toner is wetted with this cleaning fluid 623. Given the further rotation of the transfer roller 60, the cleaning fluid with the residual toner on the transfer roller 60 is exposed to an electrical field generated by the corotron 622, which recharges the residual toner, whereby the electrophoretic mobility of the residual toner in the cleaning fluid is increased. The residual toner can then migrate more easily to the cleaning roller 621 when an electrical potential UR is applied to the cleaning roller 621, which electrical potential UR is polarized such that the electrical field forces that are thereby generated between the cleaning roller 621 and the transfer roller 60 act on the charged residual toner in the direction towards the cleaning roller 621. The residual toner is then comprehensively drawn to the cleaning roller 621 and can be accepted by this roller. The residual toner (possibly with cleaning fluid) accepted by the cleaning roller 621 can be stripped from the cleaning roller 621 with the aid of a blade or scraper 625, for example, and be discharged into the pan 624, for example.

The cleaning function of the preferred embodiment is explained further using FIG. 2:

The cleaning fluid (for example carrier fluid) is taken from the pan 624 with the application roller 620 and is applied to the transfer roller 60, wherein in particular the residual toner remaining on the transfer roller 60 after the transfer printing is wetted with the cleaning fluid. The applied cleaning fluid can have a thickness of 2 to 3 μm, for example. The cleaning fluid with the residual toner is subsequently recharged by the corotron 622. The residual toner (in addition to a portion of the cleaning fluid) is electrophoretically transferred onto the cleaning roller 621 by the cleaning roller 621 with the aid of the electrical field that exists between cleaning roller 621 and transfer roller 60. For this the cleaning roller 621 lies at the electrical potential UR that is selected so that the electrical field that is thereby generated between the cleaning roller 621 and the transfer roller 60 draws the residual toner to the cleaning roller 621. Finally, the accepted residual toner together with accepted cleaning fluid is scraped off of the cleaning roller 621 by means of the blade 625.

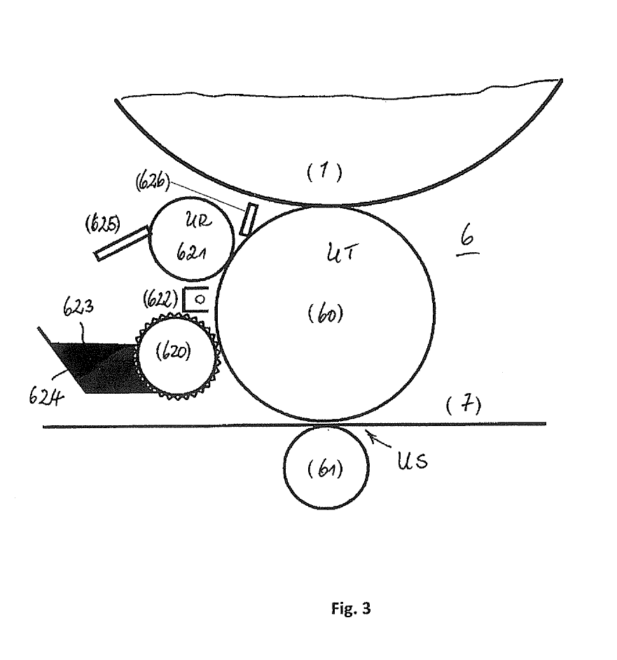

An additional optimization of the cleaning function is achieved according to FIG. 3 in that an additional blade 626 is positioned at the transfer roller 60 after the cleaning roller 621, as viewed in the rotation direction of the transfer roller 60. Residual toner and cleaning fluid that are not cleaned off the cleaning roller 621 as well as other contaminations on the transfer roller 60 can be mechanically removed with this blade 626. The discharge of cleaning fluid can thereby also be reduced since the amount that is scraped off can be captured. The additional blade 626 can be comprised of elastic material, for example polyurethane.

In addition to cleaning fluid and the residual toner, the fluid layer transported to the cleaning roller 621 by the transfer roller 60 has a quantity of carrier fluid that is dependent on the printing substrate (for example on its absorption capacity). However, in order to specifically adjust the electrophoretic mobility of the residual toner, the cleaning fluid is applied to the transfer roller 60, wherein the cleaning fluid is embodied such that the residual toner in it can move so that it can arrive at the cleaning roller 621. The transfer of the residual toner to the cleaning roller 621, and therefore the cleaning effect, is therefore no longer dependent on the residual cleaning fluid that remains on the transfer roller 60 after the transfer printing. In particular, the residual toner is recharged by the corotron 622 so that it is drawn to the cleaning roller 621 in the electrical field between the cleaning roller 621 and the transfer roller 60. Via the recharging the residual toner, independent of its previous charge, is brought to a uniform charge that is optimal for the cleaning function. Namely, before the recharging the residual toner can have an incorrect polarity in relation to the cleaning function, or can have no charge at all. In order to additionally affect the mobility of the residual toner in the cleaning fluid, charge control substances can be added to the cleaning fluid.

The transfer roller 60 and the cleaning roller 621 can be embodied in a known manner. For example, the elastically embodied transfer roller 60 can be comprised of elastomer. The cleaning roller 621 can be embodied as a ceramic roller. The application roller 620 can be realized as a raster roller with cups and webs and can likewise be comprised of ceramic. The rotation directions and the rotation velocities of the cleaning roller 621 and the application roller 620 in comparison to the rotation direction and rotation speed of the transfer roller 60 are selected so that the application of cleaning fluid onto the transfer roller 60 and the cleaning of the residual toner from the cleaning roller 621 are optimal. The cleaning roller 621 can be arranged resting on the transfer roller 60 to clean the transfer roller 60 of residual toner and cleaning fluid. The widths of application roller 620 and cleaning roller 621 are selected so that the transfer roller 60 can be sufficiently cleaned.

Although preferred exemplary embodiments are shown and described in detail in the drawings and in the preceding specification, they should be viewed as purely exemplary and not as limiting the invention. It is noted that only preferred exemplary embodiments are shown and described, and all variations and modifications that presently or in the future lie within the protective scope of the invention should be protected.

We claim as our invention:

1. A transfer unit for an electrophoretic printing or copying apparatus in which potential images generated on a charge image carrier of images to be printed are developed into toner images by liquid developer having at least carrier fluid and toner, said toner images being transfer-printed onto a printing substrate by the transfer unit at a transfer printing station, comprising:
a rotating transfer element lying at a first electrical potential is arranged adjacent to the charge image carrier and that accepts the toner images from the charge image carrier and supplies the toner images to the transfer printing station;
an application element adjacent to the transfer element after the transfer printing station and that applies a cleaning fluid onto the transfer element in order to wet residual toner remaining on the transfer element after the transfer printing;
an electrical potential element that recharges the wetted residual toner and which is arranged after the application element and adjacent to the transfer element; and
a cleaning element after the potential element and adjacent to the transfer element, said cleaning element being at an electrical potential selected so that an electrical field generated between the cleaning element and the transfer element draws the wetted residual toner towards the cleaning element.

2. The transfer unit according to claim 1 in which the potential element comprises a corotron.

3. The transfer unit according to claim 1 in which a blade that scrapes the residual toner from the cleaning element is arranged adjacent to the cleaning element.

4. The transfer unit according to claim 3 in which an additional blade that scrapes the residual toner, the cleaning fluid, and contaminations from the transfer element is arranged after the cleaning element and resting on the transfer element.

5. The transfer unit according to claim 1 in which the cleaning element is arranged at the transfer element such that it accepts the cleaning fluid in addition to the residual toner.

6. The transfer unit according to claim 1 in which the cleaning element is designed as a cleaning roller.

7. The transfer unit according to claim 1 in which the application element is designed as an applicator roller.

8. The transfer unit according to claim 7 in which the applicator roller is designed as a raster roller that takes up the cleaning fluid from a pan having the cleaning fluid and supplies it to the transfer roller.

9. The transfer unit according to claim 1 in which the carrier fluid of the liquid developer is provided as the cleaning fluid.

10. The transfer unit according to claim 1 in which charge control substances are added to the cleaning fluid.

11. A transfer unit for an electrophoretic printing or copying apparatus in which potential images generated on a charge image carrier of images to be printed are developed into toner images by liquid developer having at least carrier fluid and toner, said toner images being transfer-printed onto a printing substrate by the transfer unit at a transfer printing station, comprising:
a rotating transfer element at a first electrical potential arranged adjacent to the charge image carrier and that accepts the toner images from the charge image carrier and supplies the toner images to the transfer printing station;
an application element comprising a rotating raster roller adjacent to the transfer element after the transfer printing station and that applies a cleaning fluid comprising said carrier fluid of the liquid developer onto the transfer element in order to wet residual toner remaining on the transfer element after the transfer printing;
an electrical potential element that recharges the wetted residual toner and which is arranged after the application element and adjacent to the transfer element; and
a cleaning element after the potential element and adjacent to the transfer element, said cleaning element comprising a roller and being at an electrical potential selected so that an electrical field generated between the cleaning element and the transfer element draws the wetted residual toner towards the cleaning element.

12. A method in an electrophoretic printing or copying apparatus for cleaning a transfer unit comprising a rotating transfer element which transfers toner images developed by a liquid developer having at least carrier fluid and toner from a charge image carrier onto a printing substrate at a transfer printing station, comprising the steps of:
providing said rotating transfer element at a first electrical potential;
applying with an application element a cleaning fluid after said transfer printing station onto the transfer element to wet residual toner remaining on the transfer element after transfer printing;
recharging the wetted residual toner with an electrical potential element arranged after the application element;
providing a cleaning element after the potential element and providing an electrical potential of the cleaning element selected so that an electrical field generated between the cleaning element and the transfer element draws the wetted residual toner towards the cleaning element; and
removing the wetted residual toner drawn towards the cleaning element with the cleaning element.
